(19) United States
(12) Patent Application Publication
(10) Pub. No.: US 2023/0149137 A1
(43) Pub. Date: May 18, 2023

(54) Dental Suction Device, and Dental Suction Device and Instrument Assembly

(71) Applicant: BADIA LLORET, S.L., Barcelona (ES)

(72) Inventor: Jorge BADIA FARRÉ, Barcelona (ES)

(21) Appl. No.: 18/157,334

(22) Filed: Jan. 20, 2023

Related U.S. Application Data
(63) Continuation-in-part of application No. PCT/ES2021/070560, filed on Jul. 23, 2021.

(30) Foreign Application Priority Data
Jul. 23, 2020 (ES) P202030768

(51) Int. Cl. A61C 17/08; A61C 17/02; A61C 1/00

(52) U.S. Cl. CPC A61C 17/08; A61C 1/0046; A61C 1/0061; A61C 17/0208

(57) ABSTRACT

A dental suction device for suction of fluid deflections and aerosols produced by the effect of a drill or laser of a dental instrument inside the oral cavity, and attachment for removably attaching the dental suction device to the dental instrument, characterised in that the dental suction devices comprises a tubular body for suctioning fluid that forms a first outer cavity to receive a working head of the dental instrument, wherein a distal portion (B) of the tubular body extends radially so as to at least partially surround a perimeter of the first outer cavity housing the working head of the dental instrument, wherein a wall of the distal portion (B) of the tubular body incorporates at least one suction orifice.

### CROSS-REFERENCE TO RELATED APPLICATION

This application claims the benefit of priority, and is a continuation-in-part, of International PCT Patent Application No. PCT/ES2021/070560, filed Jul. 23, 2021, and published on Jan. 27, 2022, as WO2022/018320, which claims priority to Spanish Patent Application No. P202030768, filed Jul. 23, 2020, the disclosures of which are hereby incorporated herein by reference in their entireties.

### TECHNICAL FIELD

The present invention relates to a dental suction device suitable for suctioning aerosols and deflections of cooling fluid produced by the effect of a dental instrument such as a dental turbine, dental contra-angle handpiece or dental laser, when said instrument acts on the surface of the teeth in the oral cavity of a patient. It also refers to an assembly for a dental suction device and dental instrument.

### BACKGROUND OF THE INVENTION

A dental turbine, or a dental contra-angle handpiece, is a dental milling instrument comprising a working head with a bur rotating at a speed of100,000 to 500,000 revolutions per minute for milling hard tissues of the teeth, such as enamel or prosthetic material. The dental laser is another type of dental instrument which in this case uses a laser tip, instead of a bur, to ablate the aforementioned hard tissues.

Conventional dental turbines, contra-angle handpieces and lasers incorporate an air and water irrigation system to cool the heat produced by the friction of the drill or laser on the teeth. This cooling fluid is necessary to prevent the pulp of the tooth from overheating, and also helps to release the milled material or material resulting from the ablation, to improve visibility of the working area. However, the effect of the air jet and the cooling water on dental tissues produces suspensions of tiny particles of solids and liquids (aerosols) that are a source of disease transmission for the patient and the operator. In the case of dental lasers, in addition to the aerosol effect of the cooling fluid, there is also the effect that the laser energy produces on the water in the tissues, creating micro-explosions that project energetic particle plumes resulting from the ablation caused by the laser mixed with bacteria, viruses and multiple blood by-products.

It is well known that fluid deflections and aerosols generated during daily dental work pose a risk to both the health of the operator and patients, as they are a source of transmission of diseases and pathogens to which professionals are continuously exposed. In particular, it must be taken into account that aerosols can remain in suspension in the dental surgery environment for a time of more than four hours, which significantly increases the risk of disease transmission. This was clearly demonstrated during the SARS-CoV-2 pandemic crisis.

Dental turbines are known which incorporate in the turbine casing itself suction means for sucking into the oral cavity mainly cooling liquid and milling debris produced by the effect of the turbine’s drill. Pat. US 5,342,196 A discloses a dental turbine of this type in which the casing body of the turbine itself defines a first aerosol suction cavity and a second cavity for accommodating supply ducts for pressurised air and cooling fluid. Dental instruments such as those described in the aforementioned patent have the drawback that suction of fluid deflections and aerosols is limited to the vicinity of the area of action of the drill or laser, so that a significant percentage of ejections cannot be suctioned and are released into the environment of the box. In addition, the fluid suction flow rate provided by these dental instruments is also very poor, and clearly insufficient to ensure effective absorption of the fluid deflections and aerosols that are generated inside the patient’s oral cavity.

Dental suction devices, such as the one described in Pat. US 5,531,722 A or Pat. US5378150 A, are known, which can be removably attached to a tartrectomy device such as an ultrasonic scaler, which is used to remove tartar by means of ultrasonic vibrations. These devices also use a water irrigation system, in this case without air, the water being nebulised by the back-and-forth movement of the ultrasonic tip in a direction perpendicular to the longitudinal axis of the ultrasonic tip.

Dental suction devices such as the ones described in the aforementioned patents include a suction body which covers the ultrasonic tip by way of a screen to aspirate the liquid nebulised by the vibration. However, these devices are not suitable for absorbing the fluid deflections produced by the effect of a drill or laser but are only useful for absorbing the water mist generated by the vibration of the ultrasonic tip.

Indeed, the formation of aerosols in scalers or ultrasonic devices is completely different in quality and quantity compared to dental turbines and lasers. Scalers create a water mist in the same way as air humidifiers do. The ultrasonic back-and-forth motion of the scaler tips projects a mist of small droplets in a direction perpendicular to the longitudinal axis of the instrument tip, whereas in turbines or dental lasers, several confluent jets of pressurised water accelerated by pressurised air form a fluid ejection that travels at 12 m/s in a direction parallel to the axis of the active tip of the instrument. The aerosols produced by ultrasonic devices (“scalers”), are neither concentrated in a stream nor impelled by any gas (as in the case of turbines or lasers that require the use of a jet of water and pressurised air). In ultrasonic devices, the aerosols diffuse in a fan-shaped pattern (‘aerosol enveloppe’) until they are stopped by air or a nearby body and are easily suctioned off.

### SUMMARY OF THE INVENTION

The aim of the present invention is to solve the aforementioned drawbacks by providing a dental suction device with the advantages that will be described below.

In accordance with this objective, according to a first aspect, the present invention provides a dental suction device suitable to be coupled to a dental instrument provided with a drill or laser tip and an injection unit for injecting under pressure a jet of cooling fluid comprising a mixture of air and water. This device comprises a suction unit for sucking into the oral cavity fluid deflections and aerosols produced by the effect of the drill or laser of the dental instrument and attaching means or attachment system for removably attaching the said device to said dental instrument.

The device is characterised in that the suction unit comprises a fluid suction body, preferably a tubular suction body, forming a first outer cavity or outer housing intended to receive a dental instrument working head, wherein a distal tubular portion of the suction body extends, for example radially, so as to at least partially surround the perimeter of the outer cavity or outer housing in which the dental instrument working head is housed, and wherein a wall of said distal tubular body portion incorporates at least one suction orifice arranged so as to determine a perimeter area of fluid suction in an upward direction that at least partially surrounds the outer cavity or outer housing for receiving the working head, said distal tubular body portion being sized and configured so that it can be introduced inside the patient’s mouth while the working head of the dental instrument is operative.

The claimed device has the advantage of having a tubular suction body whose outer walls form a first outer cavity or outer housing designed to receive the head that supports the dental instrument’s bur or laser, so that the head, instead of being housed inside the tubular suction body, is located on the outside surrounded by the suction body itself, which greatly facilitates the handling of the device, constituting an accessory complement to the turbine, dental contra-angle handpiece or dental laser. In addition, the distal tubular portion of the suction body extends radially so that it surrounds the cavity or housing where the head is housed and forms a wall incorporating one or more peripheral upward suction orifices. The position of the suction orifices is adapted to the trajectory of fluid deflections and ejections of liquids and solids generated inside the oral cavity by the effect of the drill or laser.

Unlike the devices of the prior art, the device of the present invention allows fluid deflections and aerosols to be absorbed almost entirely and much more efficiently inside the circumferential area where they occur. In fact, the dental turbines with suction existing in the state of the art incorporate narrow fluid suction channels inside their casing that generate fluid turbulences that cause a markedly deficient suction. In the device of the present invention, the enlarged perimeter area of upward suction provided on the wall of the distal portion of the tubular body is arranged in such a way that it can approach the perimeter of action of the drill or laser to take advantage of the suction strength, without producing undesirable turbulences, while also covering practically the whole area where the deflections are generated. In particular, in the claimed device, the fluid deflections generated by the water and air spray jet when bouncing are effectively sucked away due to the proximity that the suction orifices can acquire to the place where this happens, and due to the barrier effect generated by the enlarged peripheral suction area provided in the distal portion of the tubular body.

The claimed device generates a circumferential suction effect designed so that, in proximity to working surfaces, the flow of spray (a mixture of air and water) injected is transformed by the effect of the suction into a stable toroidal vortex at the centre of which is the bur or laser tip. Thanks to the stability provided by the fluid movement within the toroidal vortex, the aerosol produced is very efficiently confined. In particular, the at least one suction orifice is provided in the wall of the distal tubular portion in such a way as to determine a peripheral area of fluid suction in an upward direction substantially parallel to the axis of the drill or laser tip of the dental instrument. In fact, the upward suction is in the opposite direction to the downward jet of spray (air/water mixture) that accompanies the drill or laser tip of the dental instrument.

Preferably, the suction unit of the device provides an air suction flow rate greater than the flow rate of water and air injected by the turbine. Thus, when the device is in operation, the laminar flow of incoming outside air creates a reverse curtain effect that helps to confine the turbulence of fluid deflections within the perimeter surrounding the outside cavity.

Surprisingly, the configuration of the distal portion of the tubular body that extends radially so that it surrounds the first outer cavity or outer housing where the working head of the dental instrument is housed allows high air suction flow rates to be applied, without affecting the cooling effect of the water/air mixture injected on the drilled or ablated tissues.

According to one embodiment, the wall of the distal portion of the tubular body incorporating the at least one fluid suction orifice extends radially outwards from the first outer cavity or outer housing for receiving the working head of the dental instrument with a width determined by a distance “d”. This distance “d” is sized so as to absorb fluid deflections that form an angle “α” between 30° and 60° with the axis of the drill or laser of the dental instrument head.

The device of the present invention has the advantage that the distal portion of the tubular body extends radially so that the tubular body itself surrounds the cavity or receiving housing of the working head, incorporating one or more orifices that determine a perimeter area of upward suction suitable for absorbing violent deflections of fluid which, in devices of the prior art, escape the area of action of the turbine or laser suction system.

Advantageously, the wall of the distal portion of the tubular body incorporating at least one perimeter fluid suction orifice extends radially outward from the outer receiving cavity or housing of the working head a distance “d” equal to or greater than 2 mm, preferably a distance “d” between 3 mm and 9 mm, for example, a distance between 4 mm and 8 mm.

According to one embodiment, a proximal tubular portion of the tubular body further forms a second outer cavity or housing intended to receive a dental instrument working head support neck or handle, the distal portion of the tubular body extending radially on both sides of said second outer cavity for receiving the working head support neck, and the wall of the distal portion of the tubular body also incorporating one or more suction orifices on both sides of the second outer cavity for receiving the support handle.

This embodiment has the advantage that it allows the upward suction perimeter area to extend towards the rear of the distal portion of the tubular body, thus preventing aerosol leakage through the rear of the instrument while the instrument is in operation.

In particular, advantageously, the suction body is a tubular body comprising;
the proximal tubular portion forming the second outer housing intended to receive the working head support handle of the dental instrument, and
the distal tubular portion at least partially surrounding the perimeter of the first outer receiving housing of the working head.

Preferably, the distal tubular portion extends on both sides of the second outer housing for receiving the handle, in correspondence with the neck of the handle, so that it at least partially surrounds the perimeter of both the outer cavities or outer housings for receiving the working head and the support neck of the working head. The wall of the distal tubular portion, on both sides of the second outer housing, also incorporates one or more suction orifices.

The proximal portion of the tubular body can be attached or coupled to the handle of a conventional dental turbine or laser by means of a clamp or by means of a clipping or press-fit system. For example, the clipping attachment system comprises one or more projections of the proximal portion of the tubular body that fit into the turbine or laser support handle to secure the attachment of the device to the dental instrument.

Advantageously, the peripheral area of upward fluid suction determined by one or more fluid suction orifices increases or decreases towards the more distal end of the tubular body of the device.

According to one embodiment, the distal portion of the tubular body extends radially forming a bifurcation of tubular bodies creating an intermediate hollow space intended to define the outer cavity or housing for receiving the working head of the dental instrument, said outer cavity or housing including an access hole for accessing the button on the upper part of the working head and allowing a change of turbine or contra-angle drill, without the need to uncouple the head of the device from the dental instrument. In addition, this access hole allows heads of different heights to be accommodated without altering the fit of the dental instrument in the device.

This bifurcation defines two tubular bodies in the form of branches of the suction tubular body that extend radially such that each one surrounds a portion of the perimeter of the cavity or external housing in which the dental drill or laser support head is housed. Each of these tubular bodies or branches includes a wall incorporating one or more upward perimeter suction orifices whose position adapts to the trajectory of the fluid deflections and ejections of liquids and solids generated inside the oral cavity by the effect of the turbine or laser.

According to one embodiment, the distal portion of the tubular body incorporates a plurality of upward fluid suction orifices arranged to extend peripherally around both the outer receiving cavities of the working head and the support neck of said working head. These orifices may be configured, for example, as one or more through slots provided in the bottom wall of the distal portion of the tubular body. Advantageously, the cross-section of these through orifices or slots determines a fluid passage in the bottom wall of the distal portion of the tubular body equal to or greater than 1 mm, and a perimeter area of upward suction approaching or exceeding 50 mm².

According to one embodiment, a cross-section of these through orifices or slots, in particular, the cross-section of the through orifices or slots extending at least partially on both sides of the perimeter of the second outer housing that receives the neck of the handle, includes walls of the orifices oriented vertically in a radial direction, towards the area where deflections would tend to escape. The orientation of these walls, together with the extension of the through slots towards the second outer housing, has been found to help maintain the toroidal vortex stable with its centre at the laser tip or drill, also confining the escape of aerosol in this area.

Again advantageously, the tubular body lumen has a decreasing area from the proximal portion of the tubular body towards the distal portion of the tubular body. In this way, the suction strength remains stable. Additionally, the dimensions of the distal tubular body portion are small and suitable for convenient handling of the device inside the oral cavity.

Preferably, the dental suction device comprises a vacuum source and an apparatus for connecting said vacuum source to the suction tubular body. This source is suitable for providing standard vacuum values in dental suction systems, for example, of about 160 millibars.

According to a second aspect, the present invention provides a dental suction device and instrument assembly comprising a device as claimed, and a dental turbine or dental contra-angle handpiece provided with an injection unit for injecting under pressure a jet of cooling fluid and/or spray (air/water mixture) capable of producing aerosols comprising milled particles in suspension from tooth tissues.

According to a third aspect, the present invention provides a dental suction device and dental instrument assembly comprising a device as claimed, and a dental laser provided with an injection unit for injecting under pressure a jet of cooling fluid and/or spray (mixture of air and water) capable of producing aerosols comprising plumes of particles resulting from the ablation effect produced by the laser tip on the tooth tissues.

Advantageously, the turbine, dental contra-angle handpiece or dental laser used with the claimed device are well-known conventional commercially available instruments, and the first cavity or outer housing formed by the tubular body of the device is adapted to receive a working head of said turbine or dental laser.

In the present invention, a dental turbine or dental contra-angle handpiece refers to an instrument having a working head comprising a rotor that drives a drill. The rotor is preferably driven by air compression, in the case of the turbine, or by an electric micromotor, in the case of the dental contra-angle handpiece, at a speed ranging in the case of the turbine between 100,000 and 500,000 revolutions per minute and, in the case of the contra-angle handpiece, between 20,000 and 200,000 revolutions per minute. Both the turbine and the dental contra-angle handpiece include an injecting unit for injecting a jet of pressurised water and air to compensate for the heat produced by the friction of the drill.

The term dental laser refers to an instrument with a working head including a laser tip, preferably an Erbium or Erbium-Chromium laser capable of ablating hard tissues. The dental laser also includes an injecting unit for injecting a jet of water and pressurised air to compensate for the heat produced by the ablation of the tissue.

### BRIEF DESCRIPTION OF THE DRAWINGS

The patent or application file contains at least one drawing executed in color. Copies of this patent or patent application publication with color drawings will be provided by the Office upon request and payment of the necessary fee.

To facilitate the description of what has been described above, drawings are appended which represent, schematically and only by way of non-limiting example, a practical case of realisation of the dental suction device and of an assembly of dental suction device and dental turbine to which said device is coupled.

FIG. 1 is an axonometric lower view of an embodiment of the tubular suction body of the dental suction device showing the proximal and distal portion of the suction body.

FIG. 2 is an axonometric side view of the suction tubular body of FIG. 1.

FIG. 3 is an axonometric top view of the suction tubular body of FIG. 1.

FIG. 4 is a wireframe style axonometric top view of an assembly of the tubular suction body assembly of FIG. 1 and a dental turbine.

FIG. 5 is a wireframe style axonometric lower view of the tubular suction body and dental turbine assembly of FIG. 4.

FIG. 6 is a wireframe style isometric lower view of the tubular suction body of FIG. 1.

FIG. 7 is a wireframe style isometric side view of the tubular suction body and dental turbine assembly of FIG. 4.

FIG. 8 is a cross-section of the embodiment of the distal tubular portion of the suction body of FIG. 1 comprising suction orifices with walls oriented vertically in a radial direction.

FIG. 9 is an axonometric top view of a second embodiment of the dental suction device.

FIG. 10 is an axonometric lower view of the device of FIG. 9. This figure shows the housings that form the proximal and distal tubular portions of the suction body for receiving, respectively, the head and the handle of the dental instrument.

FIG. 11 is a cross-section of the second embodiment of the distal tubular portion of the suction body of FIG. 9, at the height of the area surrounding the second outer housing that receives the neck of the turbine handle. This section includes suction orifices provided with walls oriented vertically in a radial direction at an angle β.

FIG. 12 is a schematic representation showing the coupling operation of the dental instrument, in this case a dental turbine, in the device of the embodiment of FIG. 9. For the sake of clarity, this figure does not show the orifice provided as a through slot partially surrounding the housing for receiving the head and the handle of the turbine.

FIG. 13 is a schematic representation of the claimed dental device and instrument assembly simulating the operation inside the oral cavity and the formation of the toroidal suction vortex with its centre at the bur of the dental instrument, in this case a dental turbine.

FIG. 14 is a photo of the assembly shown in FIG. 12 in operation.

FIG. 15 is a photo showing a bottom view of an embodiment of the claimed dental suction device and dental instrument assembly, wherein the outer housing of the suction body is shaped to receive the working head of a dental turbine. This photo shows the orifice provided as a through slot partially surrounding the outer housing of the suction body.

FIGS. 16a and 16b show a first and second Whatman experimental discs of cotton cellulose qualitative filters mounted on respective circular methacrylate frames to capture aerosol particles on a comparative experimental trial to show reduction of aerosols captured by the filters. The first Whatman experimental disc filter shows experimental results of subtrial I when using a prior art disposable suction cannula and a dental turbine. The second Whatman experimental disc filter shows experimental results of subtrial II when using the dental turbine coupled to the claimed dental suction device.

### DESCRIPTION OF THE PREFERRED EMBODIMENTS

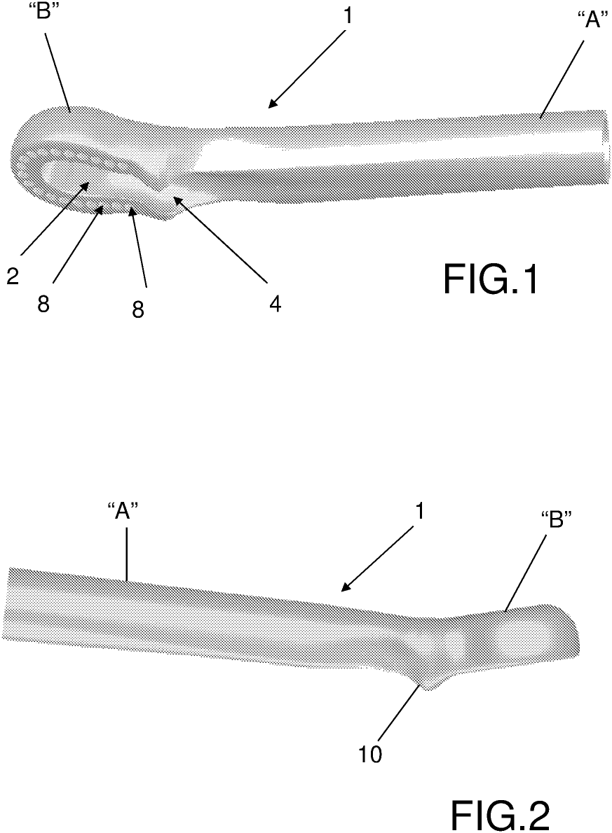

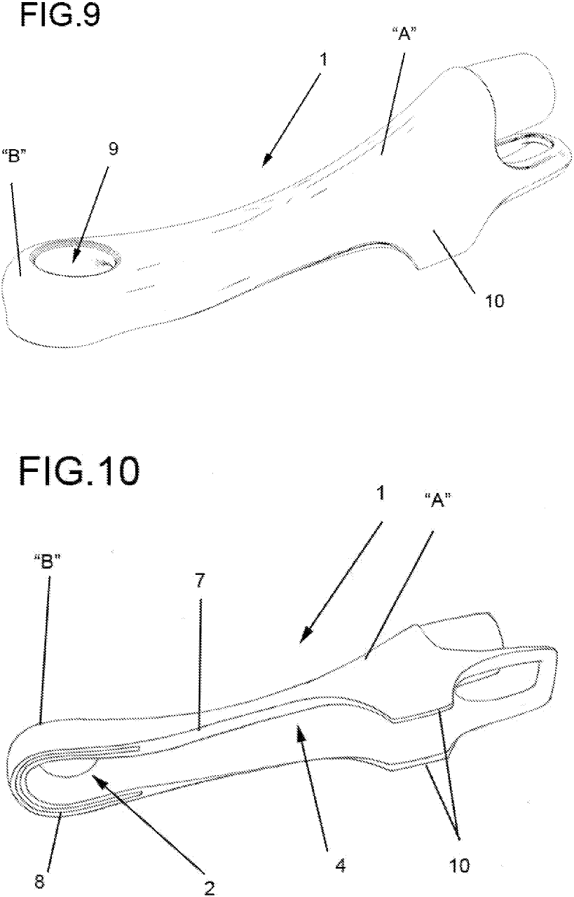

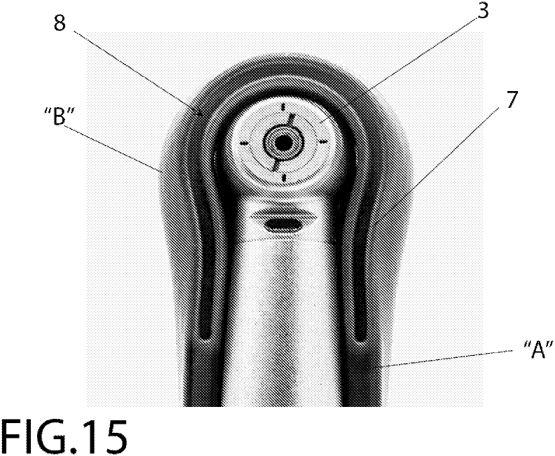

In what follows, two embodiments of the dental suction device of the present invention are described with reference to FIG. 1 to 16a and 16b.

The claimed dental suction device comprises suction means comprising a suction body 1, which is preferably a tubular body, capable of being connected to a vacuum source (not shown) suitable for providing preferably a vacuum equal to or greater than 100 millibars, for example, 160 millibars.

The outer walls of the tubular suction body 1 form a first outer cavity or housing 2 intended to receive a working head 3 of a dental instrument, and a second outer cavity or housing 4 intended to receive the handle 5 supporting the working head 3 of said dental instrument. In the embodiments described and shown in the figures, the outer cavities, or housings 2 and 4 of the tubular body 1 are shaped to receive a working head 3 and handle 5 of a dental instrument which, in this case, is a dental turbine 6 fitted with a drill 6a. However, the same tubular body 1 could comprise cavities or housings adapted to receive the head of a laser and the handle of a dental laser, respectively.

The tubular suction body 1 includes a proximal tubular portion “A” capable of being removably attached to the support handle 5 of the dental instrument by means of a clamp or by means of a clipping system, and a distal tubular portion “B” sized so that it can be introduced in the oral cavity of a patient.

In the embodiments described, the distal tubular portion “B” extends radially so as to at least partially surround the perimeter of the first outer cavity or outer housing 2 receiving the dental instrument working head 3, as well as a portion of the perimeter of the second outer cavity or housing 4 that receives the neck of support handle 5 of the dental instrument working head 3.

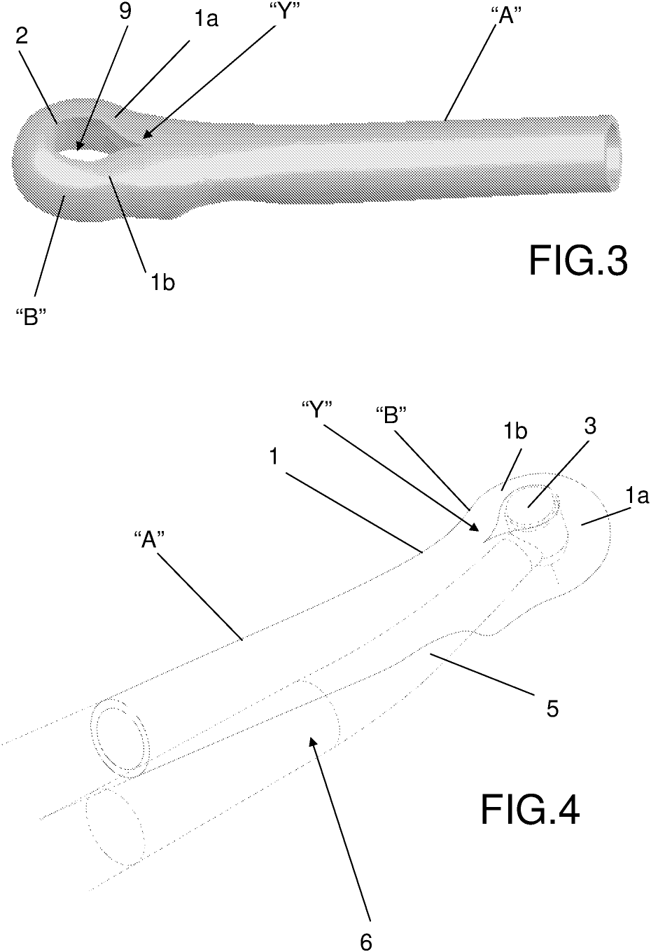

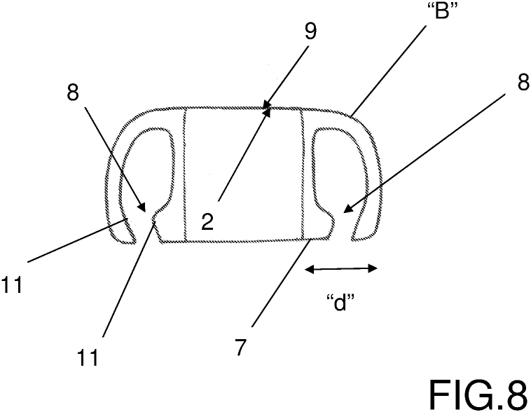

In particular, according to one embodiment, the distal tubular portion “B” of the suction tubular body 1 extends radially forming a bifurcation “Y” of tubular bodies 1a, 1b, in the form of branches, creating a hollow intermediate space defining the first outer cavity or outer housing 2 for the reception of the working head 3 of the dental instrument. As can be seen in FIGS. 3 and 4, and in FIG. 8, each of the bodies or branches 1a, 1b of the bifurcation “Y” of the distal portion “B” of the tubular body 1 extends to surround a perimeter portion of the first outer cavity or outer housing 2 of the dental instrument working head 3 and incorporates one or more suction orifices 8. The upper edge of the hollow intermediate space forms an access hole 9 which allows access to the upper part of the working head 3 where the button for clamping the drill 6a is located to allow changing the drill 6a, without the need to disengage the head 3 from the interior of the outer cavity or outer housing 2.

The figures of both embodiments of the device show a lower wall 7 of the distal tubular portion “B” of the suction body 1 which has the particularity that it extends radially outwards from both outer first and second cavities or housings 2 and 4 with a width determined by a distance “d”, and incorporates the suction orifices 8 arranged so as to determine a perimeter area of upward suction of fluid around the outer cavities or outer housings 2 and 4.

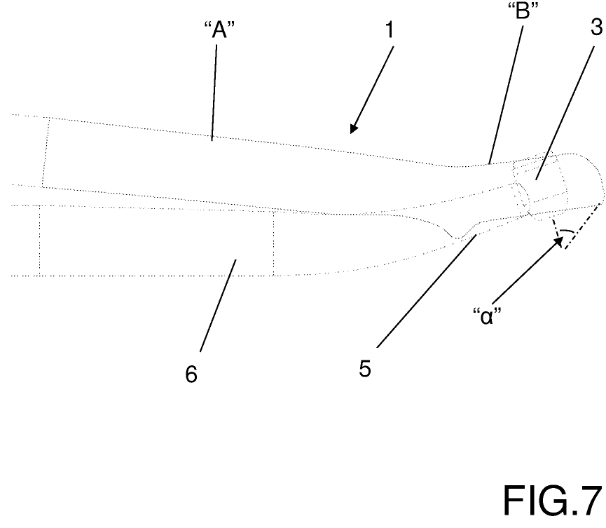

The distance “d”, or width of the lower wall 7 of the distal tubular portion “B” of the suction body, 1 is sized to absorb fluid deflections forming an angle “α” between 30° and 60° with the axis of the drill 6a or dental laser tip (see FIG. 7). In particular, the distance “d” is equal to or greater than 2 mm, preferably between 3 mm and 9 mm, or, advantageously, between 4 mm and 8 mm, as is the case in the embodiment shown in the figures (see FIG. 8).

It has been observed that these distances are adequate to provide an extended perimeter suction area that can very efficiently approach the site of projected fluid deflections and ejection of liquids and solids, which are generated inside the oral cavity by the effect of the drill 6a or dental laser, avoiding the leakage of aerosols in the anterior and posterior part of the distal portion “B” of the device.

As regards the suction orifices 8 themselves, it should be mentioned that these may be configured as through slots in the lower wall 7 of the distal tubular portion “B” of the suction body 1, as shown in FIG. 10 of the second embodiment.

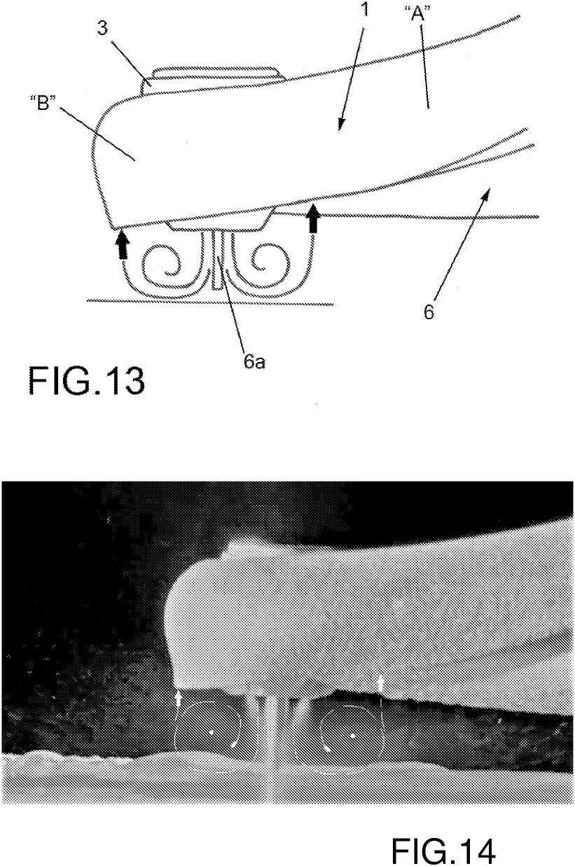

Preferably, the cross section of these orifices or through suction slots 8 determines a fluid passage in the lower wall 7 which may be equal to or greater than 1 mm and, optionally, the cross section of the orifices or through slots 8 extending on both sides of the second cavity or housing 4 for receiving the handle 5 may include walls 11 oriented vertically in a radial direction (see FIG. 11), towards the area where the deflections would escape. This detail improves the control of aerosol leakage through the rear part of the instrument by favouring a vacuum effect and the maintenance in this rear area of the stable toroidal suction vortex (see FIGS. 13 and 14).

In what follows the operation of the claimed device is described with reference to a dental instrument, which may be, for example, a dental turbine 6 provided with a working head 3 comprising a drill 6a and pressurised water and air injection means for injecting a pressurised jet of cooling fluid. Dental turbines of this type are available on the market, such as those marketed under the brand names Kaltenbach & Voigt®, NSK®, or B&W®. Such dental turbines 6 include a rotor, which is preferably driven by air compression at a speed of between 100,000 and 500,000 revolutions per minute, and a support handle 5 through which the air, water and electricity supply lines extend to the working head 3.

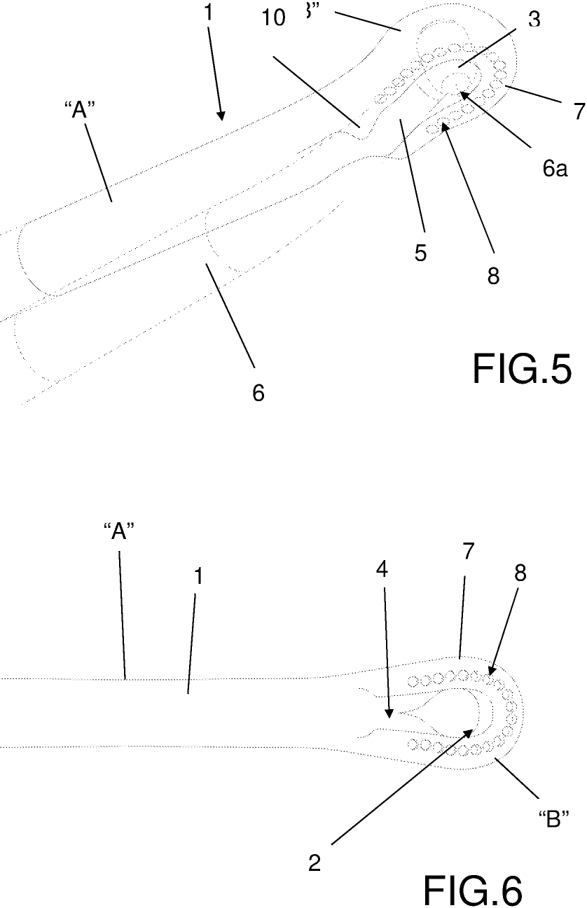

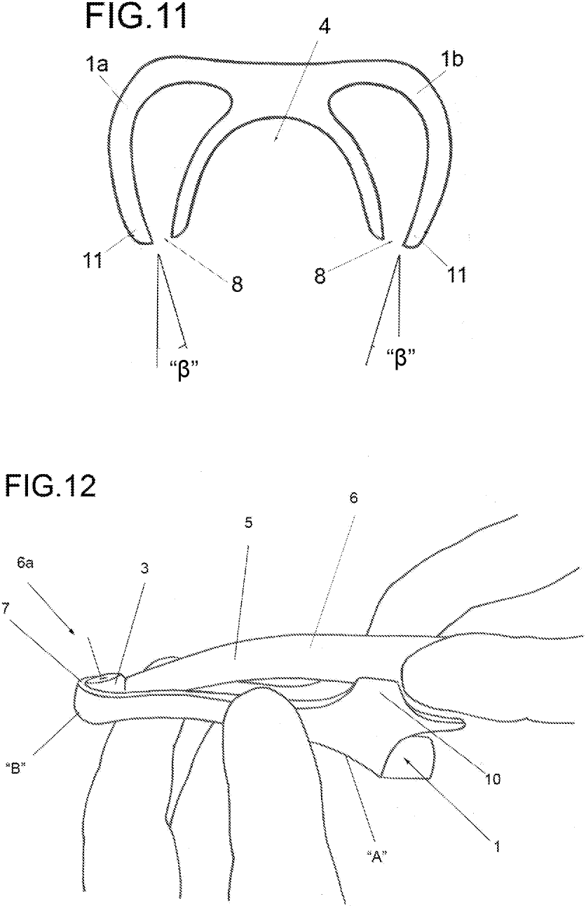

When the operator needs to carry out dental work with a dental turbine 6 as described in the previous paragraph, the device claimed is coupled first to the support handle 5 of the turbine 6, so that the working head 3 is housed inside the first outer cavity or outer housing 2 of the tubular suction body 1, and a portion of the support handle 5 itself is also housed in the second external cavity or housing 4 formed by the same suction body 1. In the embodiments described, the tubular suction body 1 is coupled to the support handle 5 by means of projections 10 provided in the proximal portion “A” of the tubular body 1 which are clipped to the support handle 5 of the dental turbine 6 (see FIGS. 5 and 12).

As can be seen in FIGS. 5 and 12, in the coupled position of the device the lower wall 7 of the distal tubular portion “B” of the suction body 1, which includes the orifices 8 or suction through slots, surrounds the working head 3 and extends towards the rear, covering a part of the perimeter of the housing 4 in which the support handle 5 is housed. The height of the distal tubular portion “B”, and in particular that of the tubular branches or body 1a, 1b, is substantially equivalent to the height of the head 3 supporting the drill 6a, which facilitates the handling of the device and dental instrument assembly inside the patient’s oral cavity, and more importantly, allows the peripheral suction area determined by the orifices 8 or suction through slots to be brought closer to the place where aerosols and fluid deflections are generated.

When the operator operates the dental turbine 6 inside the oral cavity, the pressurised spray that cools the drill 6a carries with it, on its way to and from the tooth surface, all kinds of biological products, such as bioaerosols, blood, hard or soft dental tissue, serous or purulent secretions, bacteria, or viruses, among other products and residues. However, thanks to the device of the present invention, while the dental turbine 6 is in operation, the peripheral suction area of the distal tubular portion “B” of the suction body 1 of the device suctions very efficiently the fluid deflections and ejections of particles milled and dragged by the same fluid.

It has been observed that the trajectory of the fluid deflections and ejections of milled particles is substantially circumscribed within the extended perimeter suction area determined by the orifices 8 or suction pass-through slots surrounding the head 3 and part of the neck of the handle 5, forming a stable toroidal suction vortex of fluid with its centre in the drill 6a (see FIGS. 13 and 14). Due to this, a very high percentage of these deflections and ejections are absorbed and controlled by the barrier effect generated, in the aforementioned enlarged peripheral area, by the toroidal vortex and the upwards suction.

An additional advantage of the device of the present invention lies in the fact that it makes it possible to dispense with the use of conventional suction cannulas which are manually positioned by an assistant in the vicinity of the dental turbine 6a. It has been observed that these cannulas cannot suction the totality of aerosols, or the splashes or deflections of fluid created by the presence of the cooling fluid of the drill 6a.

The claimed device has the advantage that it envelops the working area in such a way that the aerosols are very efficiently controlled, avoiding the usual leaks that occur with the use of the aforementioned cannulas. Furthermore, in the device of the present invention, the suction area is distributed peripherally, avoiding accidental deviations of cooling fluid that occur due to the lateral suction effect of the aforementioned cannulas. Accidental collisions with these are also eliminated.

Indeed, the distal portion of the tubular body comprises the peripheral suction orifice 8 which is arranged so as to determine the perimeter area of upward fluid suction which at least partially surrounds the outer receiving cavity 2 of the working head 3 of the dental instrument. This difference is essential in that it ensures the generation of a stable toroidal vortex within which the aerosol that produces the jet of pressurised water and air from the dental instrument is confined (see arrows in FIG. 14).

The claimed device generates a circumferential suction effect designed so that, in the vicinity of a working surface, the flow of spray (a mixture of air and water) injected is transformed by the effect of suction into a stable toroidal vortex in the centre of which is the drill or laser tip. Thanks to the stability provided by the fluid movement within the toroidal vortex, the aerosol produced is very efficiently confined. In particular, the at least one suction orifice 8 is provided in the wall 7 of the distal tubular portion “B” in such a way as to determine a perimeter area of fluid suction in an upward direction substantially parallel to the axis of the drill or laser tip of the dental instrument. In fact, the upward suction is in the opposite direction to the downward jet of spray (air/water mixture) that accompanies the drill or laser tip of the dental instrument.

To show the effectivity of the claimed suction device an experimental comparative trial has been carried out which shows the significative reduction of production of aerosols particles when using a dental turbine coupled to the claimed dental suction device. Below, the experimental comparative trial is described.

### Material and Method

A typical working position with a dental turbine is emulated on the second lower left premolar, in a first subtrial without using the claimed dental suction device, and in a second subtrial, using it.

With the intention of capturing the aerosol particles produced by the dental turbine, a Whatman disc of cotton cellulose qualitative filter of 15 cm in diameter and 0.18 mm thick, mounted on a circular methacrylate frame is available. This frame fits into an infundibulum connected to a suction system that sucks the air through the filter at a rate of 216 I/ min. All air flow measurements have been performed with an air column float flowmeter “ASA P13-2800”.

With the intention of objectifying the aerosol particles, sodium fluorescein (C20H10Na205) is used, which is an odourless orange powder that turns green when mixed with water. A fluorescein solution at a rate of 1 g per litre has been used.

An “Orbitec 008453” type “A” UV lamp is used to detect fluorescein in the aerosols captured by the filter.

To emulate a clinical work situation, a “Bader” phantom is attached to an AG3 permanent denture typodont on the headrest of a “DKL L2 ECO” dental unit. The phantom is separated 20 cm of the Whatman cellulose disc filter. A distilled water tank “A.E.B.” is connected to this equipment, pressurized to 3 Atm as a turbine coolant, with two litres of the fluorescein solution. A quadruple spray dental turbine “B.A. INTERNATIONAL OPTIMA BA525K” with a blunt bur or drill is placed over the mesial fossa of the second lower left premolar of the typodont. Said dental turbine operates at a regime of 300,000 r.p.m, 2.2 kgf / cm² of pressure in pipes and an intermediate water flow of 25 ml/ min.

This equipment has a “DÜRR 600” dental aspiration that develops an aspiration of 260 I / min in the 16 mm hose terminal, which places it at the lower limit of a high-volume evacuation (> 250 I / min).

A disposable suction cannula is connected to the phantom to evacuate excess fluid and emulate the flow of air entering the oral cavity.

With aspiration through the filter actuated, the dental turbine bur is placed perpendicular to the occlusal plane on the mesial fossa of the lower left first premolar and the dental turbine is operated for two minutes in each of the two experimental subtrials.

Photographs of the fluorescence on the filters are taken under ultraviolet light with a “Nikon D3000” digital camera.

The comparative trial includes two experimental subtrials:
Subtrial I: Dental turbine and saliva ejector aspirating to the maximum (at a rate of 83 I / min).
Subtrial II: Dental turbine with the claimed dental suction device connected to the 16 mm suction hose terminal and saliva ejector aspirating to a minimum.

No renewal of air was done between subtrials.

Results show that in subtrial I, all the surface of the Whatman experimental disc filter was contaminated by more than nine thousand aerosol droplets, while in subtrial II only six droplets appeared on the surface of the Whatman experimental disc filter.

In subtrial I, a disposable saliva ejector was placed in the posterior part of the oral cavity of the phantom with a maximum flow of 83 I/ min. This creates an air current that opposes the exit of the aerosol droplets to the outside as far as possible. During the test and against the backlight, the recovery of part of the aerosol was evidenced due to the establishment of said current, but it was insufficient to avoid contamination of the Whatman filter.

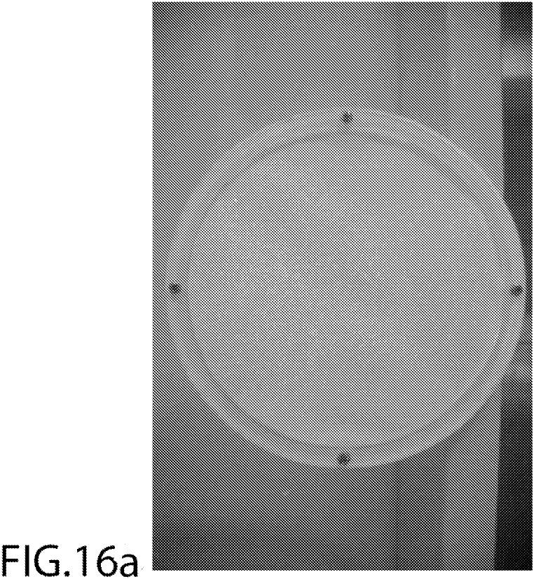

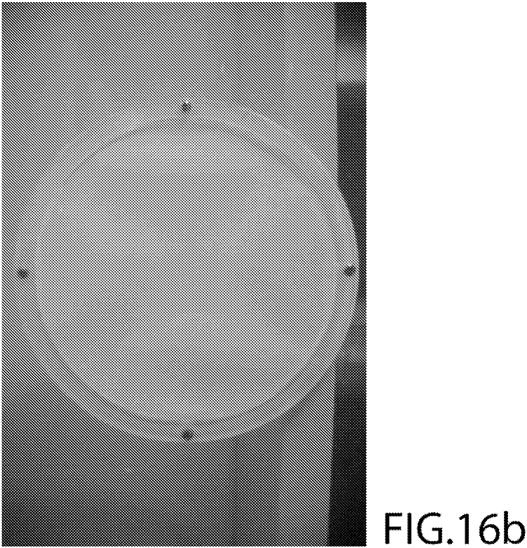

On the contrary, in subtrial II, the ejector flow was reduced to the minimum necessary to evacuate the liquid formed in the most sloping part of the oral cavity of the phantom while the claimed dental suction device connected to the aspiration system with the 16 mm hose terminal effectively blocked the exit of aerosols. As can be seen in FIG. 16b, in subtrial II, only six dimly lit spots were seen.

Therefore, the described experimental trial shows a reduction of aerosols of virtually 100% (see, FIGS. 16a and 16b), so the use of the claimed dental suction device and dental instrument assembly can be considered as an alternative for the reduction of aerosols in daily clinical practice and for preventing airborne diseases during the current pandemic.

Although reference has been made to specific embodiments of the invention, and to an experimental trial,applied to a dental turbine, it is obvious to a person skilled in the art that similar results can be obtained if the dental suction device described is applied or coupled to another dental instrument, such as, for example, a dental contra-angle handpiece or a dental laser. Thus, the claimed device is susceptible to numerous variations and modifications, so that all the aforementioned details can be replaced by technically equivalent ones without departing from the scope of protection defined by the appended claims.

1. A dental suction device to be coupled to a dental instrument provided with a drill or laser tip and an injection unit for injecting under pressure a jet of fluid comprising a mixture of air and water, wherein the device comprises:
a suction unit for suctioning inside an oral cavity deflection a fluid and an aerosol produced by an effect of the drill or laser tip of the dental instrument, and
an attachment system for removably attaching the device to the dental instrument,
wherein the suction unit comprises a fluid suction body forming a first outer housing to receive a working head of the dental instrument,
wherein a distal tubular portion (B) of the suction body surrounds at least partially a perimeter of the outer housing for receiving the working head of the dental instrument, and
wherein a wall of the distal tubular portion (B) incorporates at least one suction orifice arranged so as to determine a peripheral fluid suction area in an upward direction that at least partially surrounds the outer housing for receiving the working head, said distal tubular portion (B) of the suction body being configured and sized so that it can be introduced in a patient’s mouth while the working head of the dental instrument is operating in the outer housing of the suction body .

2. The dental suction device according to claim 1, wherein the at least one suction orifice is provided in the wall of the distal tubular portion (B) so as to determine a peripheral fluid suction area in an upward direction substantially parallel to an axis of the drill or laser tip of the dental instrument.

3. The dental suction device according to claim 1, wherein the wall of the distal tubular portion (B) extends radially outwards from the outer receiving housing of the working head with a width determined by a distance (d), the distance (d) being sized so as to absorb fluid deflections forming an angle (α) between 30°- and 60°- with an axis of the drill or laser tip of the head of the dental instrument.

4. The dental suction device according to claim 1, wherein the wall of the distal tubular portion (B) extends radially outwards from the outer receiving housing of the working head with a width determined by a distance (d) between 3 mm and 9 mm.

5. The dental suction device according to claim 1, wherein the suction body has a tubular body comprising:
a proximal tubular portion (A) forming a second outer housing to receive a handle supporting the working head of the dental instrument, and
the distal tubular portion (B) which at least partially surrounds the perimeter of the first outer housing for receiving the working head.

6. The dental suction device according to claim 5, wherein the distal tubular portion (B) extends on both sides of the second outer housing for receiving the handle, in correspondence with the neck of the handle, the wall of the distal tubular portion (B) incorporating, on both sides of the second outer housing, one or more suction orifices.

7. The dental suction device according to claim 1, wherein the distal tubular portion (B) of said suction body extends to surround the outer housing for receiving the head so as to form a bifurcation (Y) of tubular bodies forming an intermediate hollow space intended to define the first outer housing for receiving the working head, said first outer housing including an access hole for accessing an upper part of the working head and changing the drill without dislodging the working head.

8. The dental suction device according to claim 1, wherein a cross-section of the at least one suction orifice includes a wall of the orifice vertically oriented in a radial direction toward an area where fluid deflection is generated.

9. The dental suction device according to claim 5, wherein the at least one suction orifice is configured as one or more fluid suction through slots provided in the wall of the distal tubular portion (B) of the suction body in such a way that the one or more fluid suction through slots extend to determine a peripheral area of upward fluid suction that at least partially surrounds the perimeter of the outer housing for receiving the head and at least partially surrounds the perimeter of the outer housing for receiving the handle, in the area in correspondence with the neck of the handle.

10. The dental suction device according to claim 1, wherein the peripheral area of upward fluid suction increases or decreases towards the distal end of the device.

11. The dental suction device according to claim 5, wherein a lumen of the suction tubular body decreases in area from the proximal tubular portion (A) toward the distal tubular portion (B).

12. The dental suction device according to claim 5, wherein the proximal tubular portion (A) of the suction body comprises a press-fit attachment system for fitting the handle of the dental instrument inside the outer housing to receive the handle.

13. The dental suction device according to claim 1, further comprising a source of vacuum production and means for connecting said source of vacuum production to the suction body.

14. A dental suction device and instrument assembly, comprising:
a dental suction device; and
a dental turbine or dental contra-angle handpiece provided with a drill and an injection unit for injecting under pressure a fluid jet comprising a mixture of air and water capable of producing an aerosol comprising milled particles in suspension from tooth tissue,
wherein the dental suction device comprises a fluid suction body forming a first outer housing shaped to receive a working head of the dental turbine or dental contra-angle handpiece,
wherein a distal tubular portion (B) of the suction body surrounds at least partially a perimeter of the outer housing for receiving the working head of the dental turbine or dental contra-angle handpiece, and
wherein a wall of the distal tubular portion (B) incorporates at least one suction orifice arranged so as to determine a peripheral fluid suction area in an upward direction that at least partially surrounds the outer housing for receiving the working head, the distal tubular portion (B) of the suction body being configured to be introducible in a patient’s mouth while the working head of the dental turbine or dental contra-angle handpiece is operating in the outer housing of the suction body when coupled to the dental suction device.

15. A dental suction device and instrument assembly, comprising:
a dental suction device; and
a dental laser having a laser tip and an injection unit for injecting under pressure a jet of fluid comprising a mixture of air and water capable of producing an aerosol comprising a plume of particles resulting from an ablation effect produced by the laser tip on tooth tissue,
wherein the dental suction device comprises a fluid suction body forming a first outer housing shaped to receive the working head of the dental laser,
wherein a distal tubular portion (B) of the suction body surrounds at least partially a perimeter of the outer housing for receiving the working head of the dental laser, and
wherein a wall of the distal tubular portion (B) incorporates at least one suction orifice arranged so as to determine a peripheral fluid suction area in an upward direction that at least partially surrounds the outer housing for receiving the working head, the distal tubular portion (B) of the suction body being configured so that it is introducible in a patient’s mouth while the working head of the dental laser is operating in the outer housing of the fluid suction body when coupled to the dental suction device.

16. The dental suction device according to claim 1 and a dental instrument assembly, comprising a dental turbine, a dental contra-angle handpiece or a dental laser coupled to the fluid suction body of the dental suction device, wherein the distal tubular portion (B) of the suction body comprises a peripheral fluid suction orifice configured and arranged to generate a circumferential suction effect so that, in the vicinity of a working surface in a working position of the assembly, the jet of injected fluid is transformed by the effect of the circumferential suction into a stable toroidal vortex in the center of which is the drill or laser tip of the dental instrument.

17. The dental suction device and dental instrument assembly according to claim 16, wherein the fluid suction body comprises the at least one suction orifice configured as one or more fluid suction through slots provided in the wall of the distal tubular portion (B) of the suction body, in such a way that said through slot or slots extend to determine the peripheral area of upward fluid suction that at least partially surrounds the perimeter of the outer housing for receiving the head and at least partially surrounds the perimeter of the outer housing for receiving the handle, in the area in correspondence with the neck of the handle.
